(19) United States
(12) Patent Application Publication
(10) Pub. No.: US 2003/0083989 A1
(43) Pub. Date: May 1, 2003

(54) Tracking multiple payments

(76) Inventor: Kevin G. Dougall, Angus (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/259,805

(22) Filed: Sep. 30, 2002

Related U.S. Application Data
(60) Provisional application No. 60/325,574, filed on Oct. 1, 2001.

(51) Int. Cl. G06F 17/60

(52) U.S. Cl. 705/40

(57) ABSTRACT

Disclosed herein is a computer implemented management system for use by an automobile manufacturer for consolidating payments to a number of automobile parts suppliers for a number of concurrent individual payment plans, each for one tool purchased from the one of automobile parts suppliers and used in the production of automobile parts by the automobile parts supplier, comprising an entry screen module for entering payables data for each tool from the automobile parts supplier; the entry screen module having a number of fields to receive a number of data items including a time period over which payments are to be made; and a total amount to be paid over the time period; the fields also including one or more of; a tool identification code; an automobile parts supplier identification code; a payment plan start date; a payment plan end date; and a payment plan rate; a calculation module for calculating a payment plan for each of the incremental payments to be made over the payment period, said accounting module generating a data set encoding the payment plan; a database for storing the data sets; a payment module for assembling a payment transaction instruction for each of a series of successive payment periods, the payment transaction instruction including a payment code for each of the automobile suppliers due to be paid in the payment period, each payment code including the incremental payments to a corresponding automobile supplier; and an output module for generating an output report including the payment transaction instruction.

### REFERENCE TO CO-PENDING APPLICATIONS

The entire subject matter of U.S. Provisional application serial number 60/325,574 filed Oct. 1, 2001 and entitled TRACKING MULTIPLE PAYMENTS is incorporated by reference. The applicant claims priority benefit under Title 35, United States Code, Section 119(e) of U.S. Provisional application serial number 60/325,574 filed Oct. 1, 2001 and entitled TRACKING MULTIPLE PAYMENTS.

### BACKGROUND OF THE INVENTION

1. Field of the Invention

The present invention relates to methods of tracking or consolidating monthly payments, for example used by an automobile manufacturer to reimburse automobile parts suppliers.

2. Description of the Related Art

It is a common task for any business enterprise to track payables as part of its accounting functions. A myriad of software programs are available to perform this task.

For a large enterprise such as an automobile manufacturer, the payables function involves the work done by a supplier on a new model, an existing model or a previous model.

To manufacture an automobile part, the parts supplier will usually build a custom tool. It is not uncommon for the automobile manufacturer to ‘lease’ the tool. In other words, the automobile manufacturer will make regular payments on the tool during its operating life and then assume ownership after the payments have been made. The ownership of the tool might, for example, take effect when the tool has ended its function to fabricate parts for a current model and is then used to fabricate after-market parts and then disposed of. Though this payment arrangement presents advantages for the automobile supplier, tracking these payments is difficult, especially when the manufacturer is dealing with many different suppliers, many different tools and different payment arrangements for each.

Even with the range of accounting software available, it is not uncommon for these records to be tracked in a relatively simple spread sheet software, for example that under the trademark MICROSOFT EXCEL™. Despite the benefits that spreadsheet programs like this can provide, they involve a considerable amount of manual input to update and monitor and therefore this increases the chance of error.

It is an object of the present invention to provide an improved system to tracking multiple payments.

### SUMMARY OF THE INVENTION

Briefly stated, exemplary embodiments of the invention involve a computer implemented management system for use by an automobile manufacturer for consolidating payments to a number of automobile parts suppliers for a number of concurrent individual payment plans, each for one tool purchased from the automobile parts supplier and used in the production of automobile parts by the automobile parts supplier, comprising:

an entry screen module for entering data for each tool from invoice documents supplied by the automobile parts supplier; the entry screen module having a number of fields to receive a number of data items including:

a time period over which payments are to be made; and

a total amount to be paid over the time period;

the fields also including one or more of:

a tool identification code;

an automobile parts supplier identification code;

a payment plan start date;

a payment plan end date; and

a payment plan rate;

a calculation module for calculating a payment plan for each of the incremental payments to be made over the payment period, said accounting module generating a data set encoding the payment plan;

a database for storing the data sets;

a payment module for assembling a payment transaction instruction for each of a series of successive payment periods, the payment transaction instructions including: a payment code for each of the automobile suppliers due to be paid in the payment period, each payment code including the incremental payments to a corresponding automobile supplier; and

an output module for generating an output report including the payment transaction instruction.

In one embodiment, the entry screen module further provides a graphical user interface including a window corresponding to each field. The windows corresponding to the tool identification code, the automobile parts supplier identification code each include a window menu. The entry screen module further comprises a quote number generator for assigning one or more quote numbers for each data set. The graphical user interface also provides windows, with or without a window menu:

to select a currency for the data set;

to select an alternative condition where the data set covers only one incremental payment;

to select a project in which the subject tool is to be used;

to select an internal entity within the automobile manufacturer who has responsibility for the subject tool.

In one embodiment, the graphical user interface further includes a window to receive text comments concerning a payment plan for a particular tool. In one embodiment, the entry screen module includes a graphical user interface which provides a first user-initiated function to enter a new tool quote number, and/or a second user-initiated function to adjust one or more of the incremental payments for a subject tool, and/or a third user-initiated function to edit an existing data set for adjust one or more of the incremental payments for a subject tool. In one example, the graphical user interface further comprises a window, operable in response to the first, second or third user-initiated functions, with or without a window menu, to select a parts supplier, a project code, an effective adjustment date, a quote number for the subject tool, or to identify if the adjustment is an early buy out, or to enter text for explanatory comments on the adjustment, or a combination thereof.

In one embodiment, the payment code includes a sum of the incremental payments to each of the automobile suppliers and an identification of each of the incremental payments included in the sum. The term “buy out” is intended to mean a payment to cover all remaining incremental payments.

Preferably, selected ones of the payment transactions are recorded on or transferred by suitable media for use by a subsequent payment module. In one embodiment, the media is a computer readable medium. In another embodiment, the media is a data-bearing message. In still another embodiment, the subsequent payment module is resident in the system.

In another of its aspects, the present invention provides a computer-readable data structure for use by an automobile manufacturer, encoded on a computer readable medium, for consolidating payments to a number of automobile parts suppliers for a number of concurrent individual payment plans, each for one tool purchased from the automobile parts supplier and used in the production of automobile parts by the automobile parts supplier, comprising:

a plurality of automobile parts supplier data groups, each for storing information for a corresponding automobile parts supplier, each of said automobile supplier data groups including a plurality of automobile parts supplier tool account subgroups, each for storing information for each automobile parts supplier tool account,

each of said tool account subgroups including a plurality of entry data sets, one of said data sets for receiving data encoding a time period over which payments are to be made; and another of said data sets receiving data encoding a total amount to be paid over the time period;

the tool account subgroups also including a plurality of data sets, each for receiving data encoding one or more of a tool identification code, an automobile parts supplier identification code, a payment plan start date, a payment plan end date; and a value for each incremental payment to be made over the time period, and a payment plan rate.

Preferably, the data groups further comprise one or more data sets for encoding a payment transaction, the data sets including a payment code for at least one of the automobile suppliers due to be paid in the payment period, the payment code including a sum of each of the incremental payments to each of the automobile suppliers.

In another of its aspects, the present invention provides a computer program product encoded in a computer readable medium including a plurality of computer executable steps for consolidating payments to a number of suppliers for a payment plan for a plurality of tools used in the production of articles, comprising:

generating a payment plan, including the steps of:

generating an entry screen for receiving data for each tool from each supplier, including, in the entry screen, a first field for receiving a time period over which payments are to be made, a second field for receiving a total amount to be paid over the time period, a number of fields including: a tool identification code, an automobile parts supplier identification code, a payment plan start date, a payment plan end date, and a payment plan rate;

calculating a payment plan for each of the incremental payments to be made over the payment period;

generating a data set encoding the payment plan for each supplier;

storing the data sets; and

generating a consolidated payment for at least one of the suppliers, including the step of:

assembling a payment listing for each of a series of successive regular payment periods, the payment listing including a payment code for at least one of the suppliers due to be paid in the payment period, the payment code including a sum of each of the incremental payments to each of the suppliers.

Preferably, the computer program product further comprises the step of generating an output report including the payment listing.

In still another of its objects, the present invention provides a computer implemented management system for use by an automobile manufacturer for consolidating payments to a number of automobile parts suppliers for a number of concurrent individual payment plans, each for one tool purchased from the one of automobile parts suppliers and used in the production of automobile parts by the automobile parts supplier, comprising:

an entry screen means for entering payables data for each tool from the automobile parts supplier; the entry screen means having a number of fields to receive a number of data items including:

a time period over which payments are to be made; and

a total amount to be paid over the time period;

the fields also including one or more of:

a tool identification code;

an automobile parts supplier identification code;

a payment plan start date;

a payment plan end date; and

a payment plan rate;

calculation means for calculating a payment plan for each of the incremental payments to be made over the payment period, said accounting module generating a data set encoding the payment plan;

data storage means for storing the data sets;

payment means for assembling a payment transaction instruction for each of a series of successive payment periods, the payment transaction instruction including a payment code for each of the automobile suppliers due to be paid in the payment period, each payment code including the incremental payments to a corresponding automobile supplier; and

output means for generating an output report including the payment transaction instruction.

In still another of its objects, the present invention provides a computer implemented method for consolidating payments to a number of suppliers for a payment plan for a plurality of tools used in the production of articles, comprising:

a step for generating a payment plan, including:

a step for generating an entry screen for receiving data for each tool from each supplier, including, in the entry screen, a first field for receiving a time period over which payments are to be made, a second field for receiving a total amount to be paid over the time period, a number of fields including: a tool identification code, a parts supplier identification code, a payment plan start date, a payment plan end date, and a payment plan rate;

a step for calculating a payment plan for each of the incremental payments to be made over the payment period;

a step for generating a data set encoding the payment plan for each supplier;

a step for storing the data sets; and

a step for generating a consolidated payment for at least one of the suppliers, including:

a step for assembling a payment listing for each of a series of successive regular payment periods, the payment output including a payment code for at least one of the suppliers due to be paid in the payment period, the payment code including a sum of each of the incremental payments to each of the suppliers.

### BRIEF DESCRIPTION OF THE DRAWINGS

Several preferred embodiments of the present invention will be provided, by way of example only, with reference to the appended drawings, wherein:

FIG. 1 is a schematic view of a system for tracking multiple payments;

FIG. 2 is another schematic view of the system of FIG. 1;

FIG. 2a is a schematic view of a data structure;

FIGS. 3, 4, 4a, 4b, 5, 6, 7, 8, 9, 9a, 9b, are screen views of another system for tracking multiple payments; and

FIGS. 10 through 14 are schematic flow diagrams illustrating functions of the system illustrated in FIG. 3.

### DESCRIPTION OF THE PREFERRED EMBODIMENTS

Referring to the figures, there is provided a computer implemented management system 10. As will described, it can be used by an automobile manufacturer for consolidating payments to a number of automobile parts suppliers. It is particularly useful for tracking those concurrent payment relating to tools purchased from the automobile parts suppliers, for the production of automobile parts.

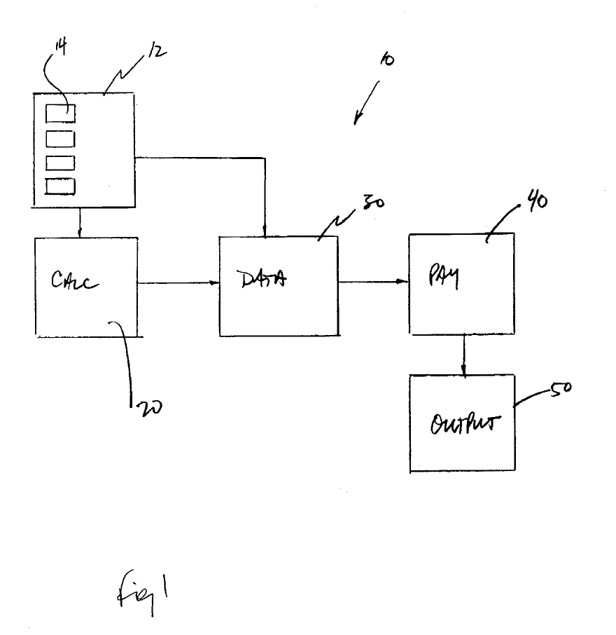

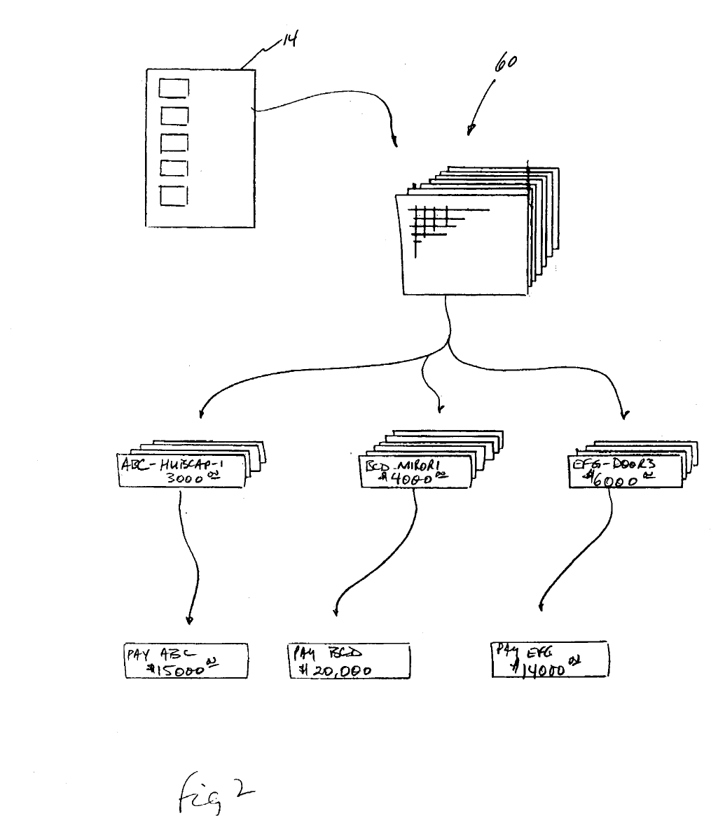

As shown in FIG. 1, the system has an entry screen module 12 for entering data for each tool from invoice documents supplied by the automobile parts supplier; the entry screen module having a number of fields 14 to receive a number of data items. The fields include a time period over which payments are to be made and a total amount to be paid over the time period. The fields also include one or more of:

a tool identification code;

an automobile parts supplier identification code;

a payment plan start date;

a payment plan end date; and

a payment plan rate;

The system may alternatively not have a payment plan rate window. In this case, the payment plan rate may already be taken into account in the calculation of the total amount to be paid over the time period.

The system has a calculation module 20 for calculating a payment plan for each of the incremental payments to be made over the payment period, the accounting module generating a data set encoding the payment plan.

The entry screen and the calculation module communicate with a database 30 for storing the data sets.

A payment module 40 receives the data from the database 30 and assembles a payment transaction instruction for each of a series of successive payment periods, the payment transaction instructions which include a payment code for each of the automobile suppliers due to be paid in each payment period, the payment code including a sum of each of the incremental payments to each of the automobile suppliers.

An output module 50 receives data from the payment module and generates an output report including the payment transaction instruction.

The computer implemented system may be provided in a number of forms, all known to those of ordinary skill in the art. It may be embodied in a software program configured to run on a general purpose computer, such as personal computer, or on a more substantial computer mainframe. The general purpose computer may work within a network involving several general purpose computers, for example those sold under the trade names APPLE™ or IBM™, or clones thereof, which are programmed with operating systems known by the trade names WINDOWS™, LINUX or other well known or lesser known equivalents of these. The system may involve pre-programmed software using a number of possible languages or a custom designed version of a programming software sold under the trade name ACCESS™ or similar programming software. The computer network may be a wired local area network, or a wide area network such as the Internet, or a combination of the two, without or without added security, authentication protocols, or under “peer-to-peer” or “client-server” or other networking architectures. The network may also be a wireless network or a combination of wired and wireless networks. The wireless network may operate under frequencies such as those dubbed ‘radio frequency’ or “RF” using protocols such as the 802.11, TCP/IP, BLUE TOOTH and the like, or other well known Internet, wireless, satellite or cell packet protocols. The system may, alternatively, be executed on a single custom built computer which is dedicated to the function of the system alone.

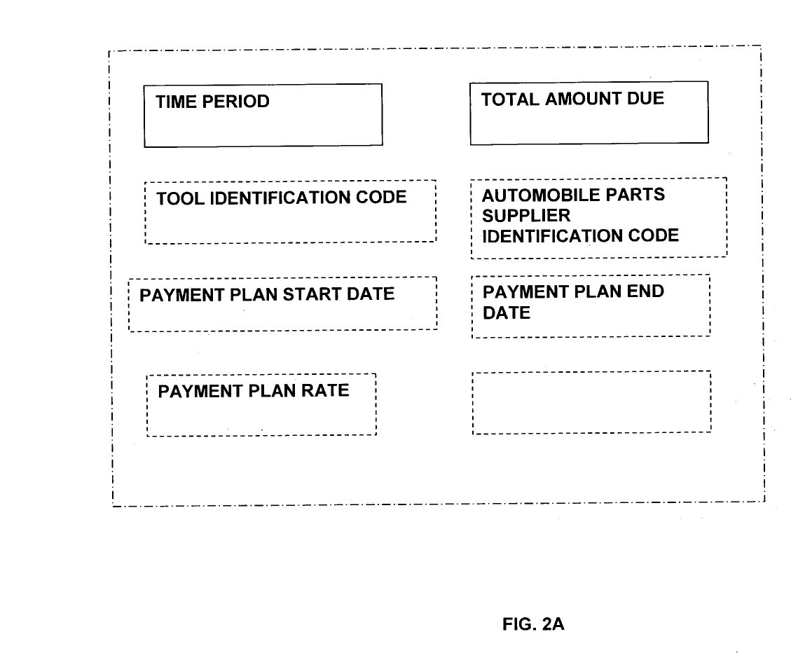

Thus, as shown by FIG. 2a, the computer implemented system provides for a number of data groups to be stored in a database. In this case, each data group stores information for each automobile parts supplier and each includes a plurality of automobile parts supplier tool account subgroups. Each supplier tool account subgroup stores information for each automobile parts supplier tool account. More particularly, each tool account subgroup includes a plurality of data sets, each encoding data for a total amount to be paid over a time period and a time period over which payments are to be made. In addition, the tool account data group includes data sets which encode data for one or more of a tool identification code, an automobile parts supplier identification code, a payment plan start date, a payment plan end date; and a payment plan rate. The data sets may also encoded other data as needed.

Referring to FIG. 2, the system works as follows. The system operator calls up the entry screen and, with the invoice information at hand, enters the relevant payables data into the appropriate fields. As the entry screen appears, the system assigns the screen a quote number, which is consecutively numbered from the previous entry screen activity for the immediately preceding entry. However, the coding can be of some other arrangement if desired, such as based on a day-month-year-daily incidence calculation such as 12-31-2001-1.

Consider, as an example, an automobile parts suppler ABC Inc. has issued an invoice for a tool costing $CDN 200,000, which with the Canadian Goods and Services Tax amounts to $CDN 214,000. The tool is for making special hubcaps. The tool has a code number “HUBCAP-1 ” on the invoice or may alternatively be available from a drop down menu. Thus, from the entry screen fields, the tool code “HUBCAP-1” is entered, as is the “ABC” code for the supplier, which may alternatively be available in a drop down menu. The invoice indicates that the tool is to be commissioned for use on Jan. 1, 2002 and will be in operation for 36 months making hubcaps. The payment plan rate is six percent. Accordingly, the system operator lists the payment start date, the payment frequency, the payment end date and the total invoice cost.

The system operator then saves the information using the appropriate save command. This triggers the system to calculate the “regular payment” figure which is presented by the system in the field of the same name and this, as well as the other input data, is then stored in the data base by the software.

This process is repeated for each invoice, thereby accumulating a number of data groups 60 each for a number of tools, all requiring payments to be made over a number of payment periods to a number of different suppliers.

The system operator will, in the payment phase, instruct the software to generate a payment report for each payment period. In this case, the payment module receives the data from the database and assembles a payment transaction instruction for each of a series of one or more successive payment periods. In the case of FIG. 2, the payment period has payments for three suppliers. ABC has four payments due, BCD six payments due and EFG four payments due.

The payment transaction instructions thus include a payment code for three automobile suppliers, in this example, due to be paid in the payment period, the payment code including a sum of each of the incremental payments to each of the three automobile suppliers. An output module generates an output report including three payment transaction instructions. The payment code may also include item details to explain the source of each incremental payment.

Thus, the output report can be of any number of forms, as are known to those of skill in the art. It may be in paper form, summarizing the total payments to be made to each supplier who is owed a payment for that particular payment period. In this case, the accounts payable department may arrange for payment, either through a direct electronic payment transaction over a computer network, such as an internal or external network, such as the internet, by way of a wire transfer or some other direct transaction between the supplier and the manufacturer or through one or more intermediaries, for example a bank-to-bank transaction between accounts of the supplier and the manufacturer. Alternatively, the payment may be in the form of a paper cheque, or some other form of monetary compensation.

Normally, the full payment of the tool will coincide with the end of the tool's operating life in the mass production of a current model. The system allows the system operator to enter a quote, its source, currency, frequency and the like and the system will establish the accurate payments flowing out of accounting as a result. The payments may be monthly, regular or irregular. The payments may include one or more months of a payment adjustment, to make up for payables delays and the like.

The system adds a monthly payment on each tool to an aggregate payment to the supplier, each aggregate payment including a list of the monthly payments owed to the supplier.

The benefits from the system are numerous. It ensures that no overpayments or underpayments will be made, nor will more payments be made than are necessary to meet the obligations for the particular tool to the supplier. For one month, there may be, say, ten suppliers owed a payment, the following month eight, and the following month twelve, depending on the cumulative list of payments due to suppliers for each particular month.

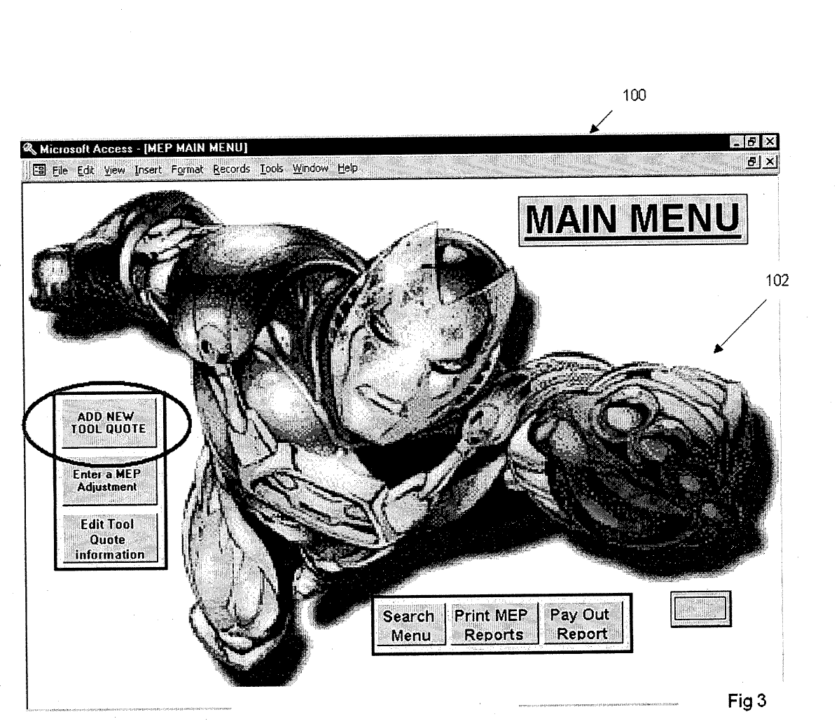

FIGS. 3 to 14 illustrate another computer implemented management system 100 of the type described above. The system is embodied in a programmable software known under the trade name MICROSOFT ACCESS™. Those features inherent in the software and which are believed to be understood by those of ordinary skill in the art, will not be discussed for the sake of brevity. In all cases where a window is displayed with a ‘drop down’ menu, it will be understood that other window menu formats may be used. In addition, the window menu function itself need not be mandatory. The user may type data into the window, as desired. The FIGS. 3 to 14 illustrate several of the graphical user interfaces that are presented by the software during its use.

FIG. 3 illustrates a main menu screen 102 having an ADD NEW TOOL QUOTE button, an ENTER AN MEP ADJUSTMENT button, and an EDIT TOOL QUOTE INFORMATION button. The main screen 102 also has a SEARCH MENU button a PRINT MEP REPORTS button and a PAY OUT REPORT button.

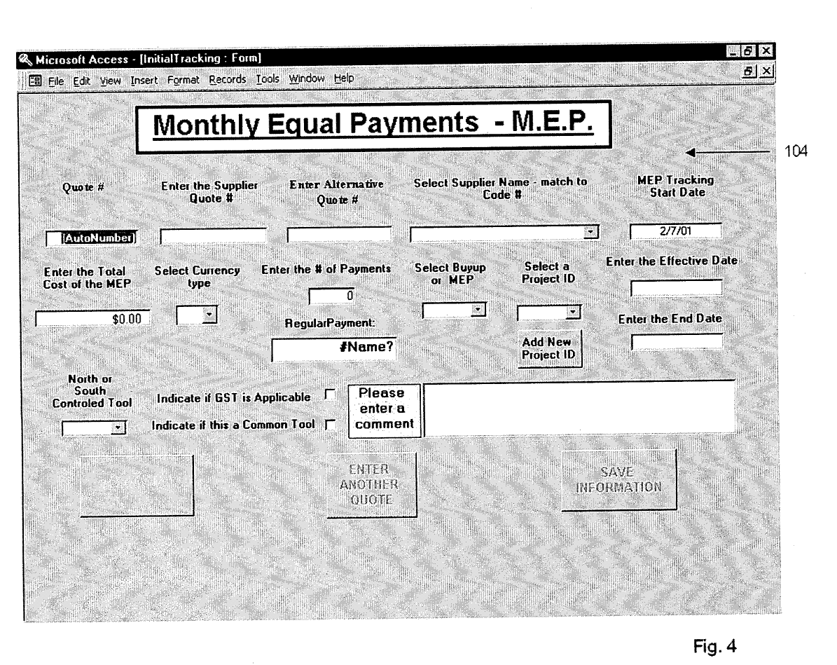

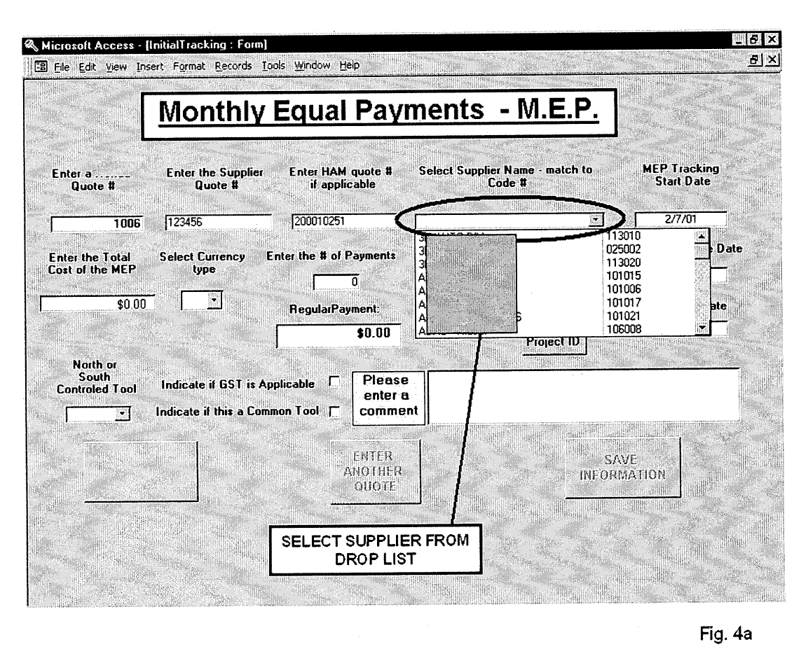

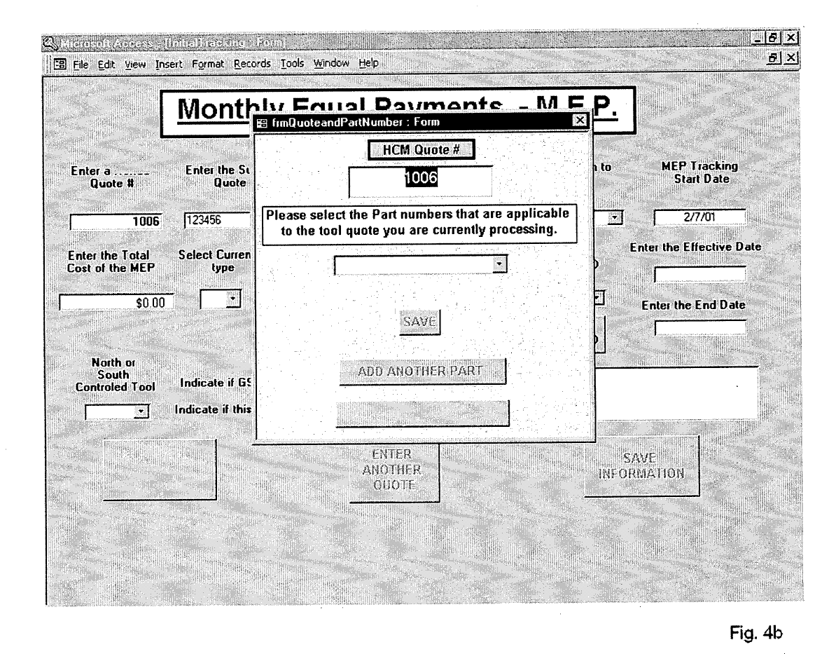

Pressing the ADD NEW TOOL QUOTE button launches a subroutine within the program which presents the MONTHLY EQUAL PAYMENTS screen 104 of FIG. 4. It contains a number of windows labeled: QUOTE #, ENTER SUPPLIER QUOTE #, ENTER ALTERNATIVE QUOTE NUMBER, SELECT SUPPLIER NAME, MEP TRACKING START DATE, ENTER TOTAL COST, SELECT CURRENCY TYPE, ENTER # PAYMENTS, REGULAR PAYMENT, SELECT BUY UP OR MEP, SELECT PROJECT ID, ENTER EFFECTIVE DATE, ENTER END DATE.

The screen 104 also contains a window labeled NORTH OR SOUTH CONTROLLED TOOL, which permits the user to identify an internal entity within the organization who has responsibility for the tool. In this case, the entity may be a division, a department, a team, an individual or the like. The screen 104 also has a window labeled INDICATE IF GST IS APPLICABLE which, when checked, indicates that taxes are applicable to the tool.

The screen 104 also has a window labeled INDICATE IF THIS IS A COMMON TOOL. This feature is useful for flagging tools which are used in common between different operating divisions of the same corporate entity. For example, two divisions may manufacture the same vehicle type and require the same tools for many of the components in them. The advantage of the window is that it permits the common tool payment transactions to be tracked so that an internal payback can be arranged internally within the divisions.

The QUOTE # window is formatted so that the system automatically presents a new quote number for each separate MEP entry. However, the window may be formatted, if desired, so that the valve is manually entered.

Each of the ENTER SUPPLIER QUOTE #, ENTER ALTERNATIVE QUOTE #, ENTER TOTAL COST, ENTER EFFECTIVE DATE, and ENTER END DATE windows are formatted for manual entry from invoice documents or payables data in other formats such as an electronic file encoding the payables data, as provided by the automobile parts supplier or an intermediary.

The MEP TRACKING START DATE window is formatted to receive the current calendar date, though the window may also be formatted to accept manually entered dates if desired.

The ENTER SUPPLIER NAME window provides a drop down menu presenting a list of available suppliers. Similarly, the SELECT CURRENCY TYPE window provides a drop down menu presenting a list of available currencies. The SELECT PROJECT ID window also provides a drop down menu presenting a list of available projects to which each MEP entry may be applied.

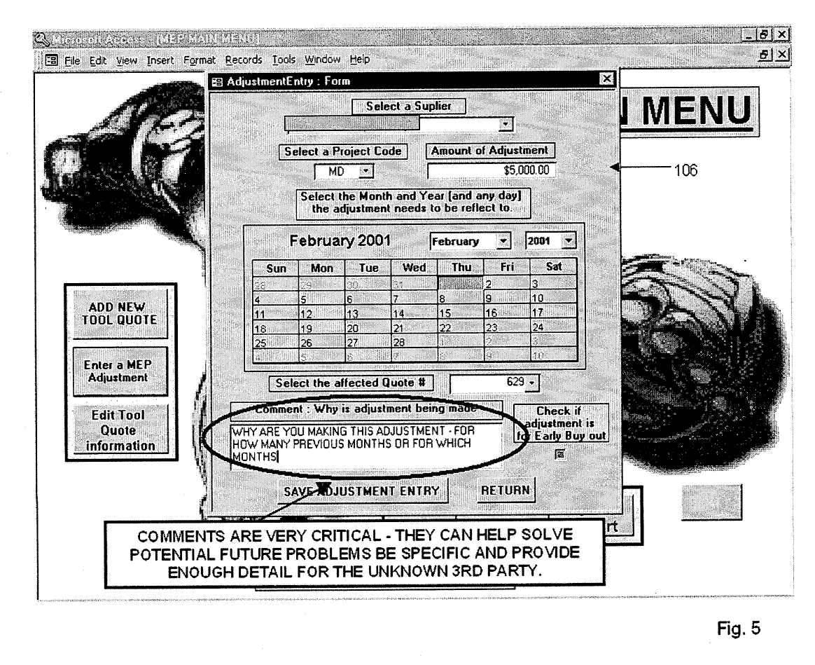

Referring again to FIG. 3, pressing the ENTER AN MEP ADJUSTMENT button launches a subroutine within the program which presents the ADJUSTMENT ENTRY FORM screen 106 as shown in FIG. 5. It contains a number of windows labeled SELECT A SUPPLIER, SELECT A PROJECT ID and AMOUNT OF ADJUSTMENT. The ADJUSTMENT ENTRY FORM screen 106 also provides an ADJUSTMENT DATE entry area which, in this case, presents each month in a calendar format (though other formats are applicable, if desired). The ADJUSTMENT ENTRY FORM screen 106 also includes a window labeled SELECTED THE AFFECTED QUOTE #, a COMMENT window and a check window to select if the adjustment is for an EARLY BUY OUT.

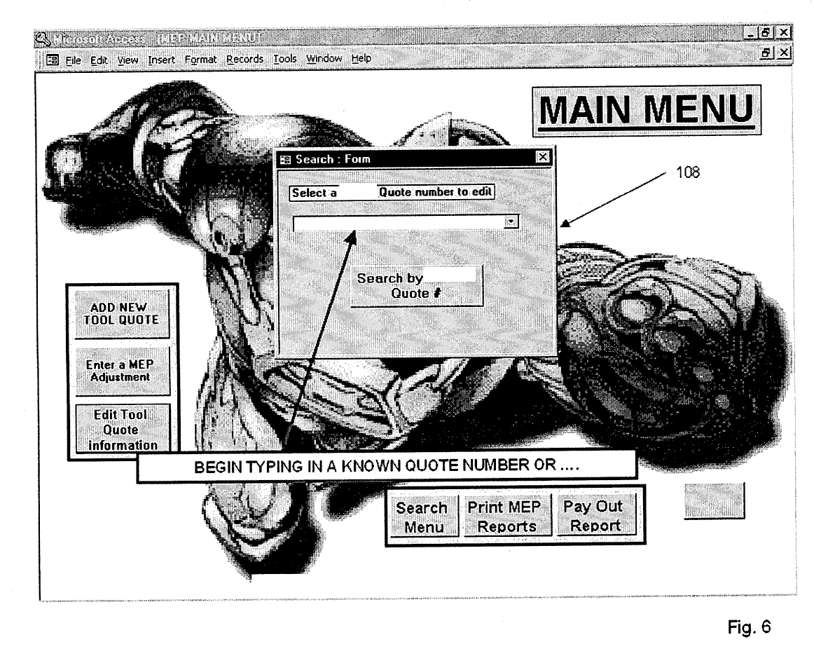

Referring again to FIG. 3, pressing the EDIT TOOL QUOTE INFORMATION button launches a subroutine within the program which presents the SEARCH FORM 108 screen shown in FIG. 6. The SEARCH form has a window labeled SELECT A QUOTE NUMBER TO EDIT which provides a drop down menu of available quote numbers. The search form also has a button labeled SEARCH BY QUOTE # which permits a search function as its label suggests.

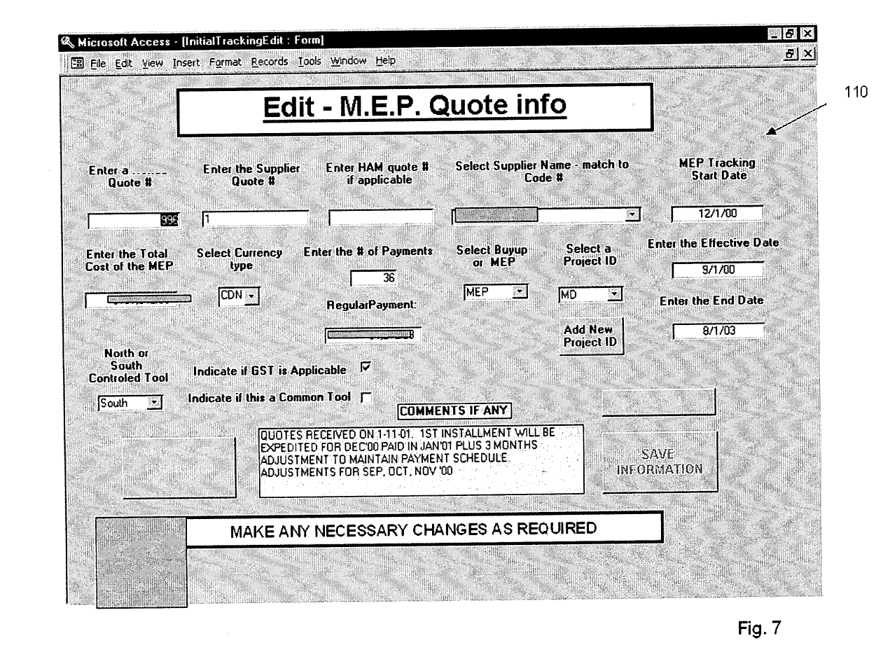

The entry of searchable data in the SEARCH FORM screen 108 then triggers another subroutine which presents an EDIT MEP QUOTE INFO screen 110 as shown in FIG. 7 which is similar to the MONTHLY EQUAL PAYMENTS screen 124. It is in this EDIT MEP QUOTE INFO screen 110 that the user can adjust an entry as necessary.

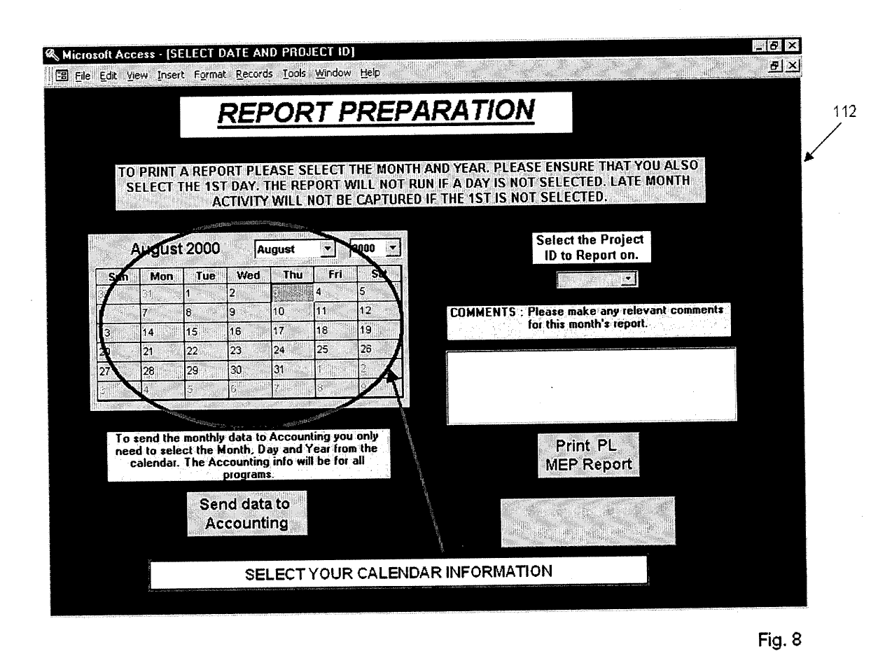

Referring again to FIG. 3, pressing the PRINT MEP REPORTS button launches a subroutine within the program which presents the REPORT PREPARATION screen 112, as shown in FIG. 8. It contains a window labeled SELECT A PROJECT ID, together with a CALENDAR window and a COMMENTS window. The REPORT PREPARATION screen also includes a SEND DATA TO ACCOUNTING button and a PRINT PL MEP REPORT button. The SEND DATA TO ACCOUNTING button, when pressed, instructs the software to generate a computer file which encodes the payment transaction instruction for the period of time identified in the calendar window. The PRINT PL MEP REPORT button, when pressed, instructs the software to generate a readable display of the payment transaction instruction, readable by the user, either in paper form, on a screen or in some other manner.

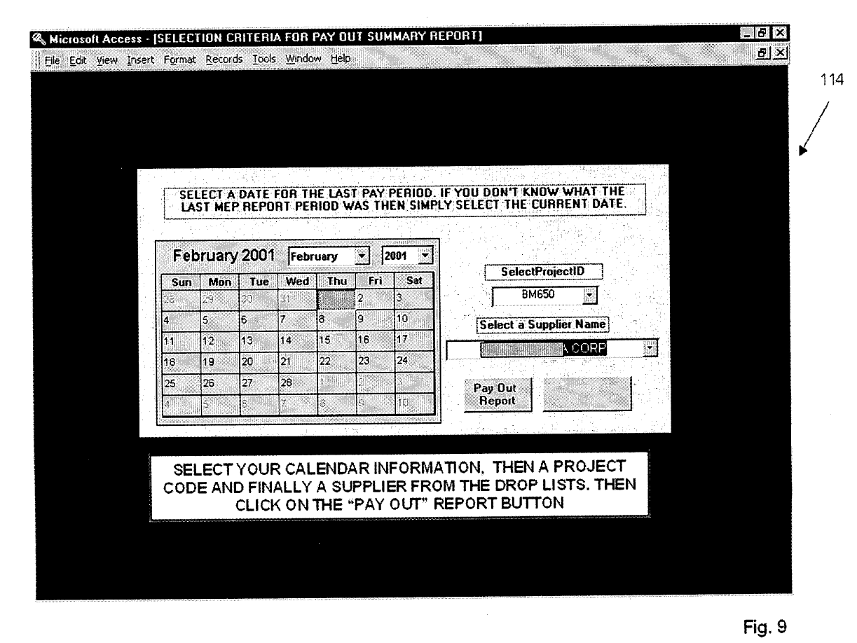

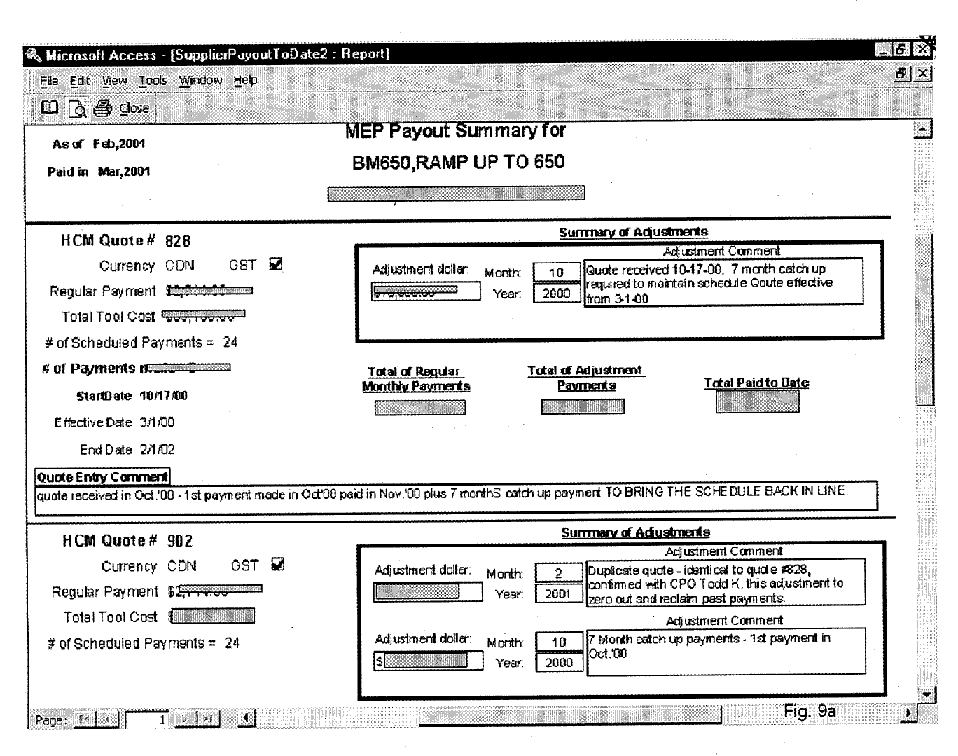

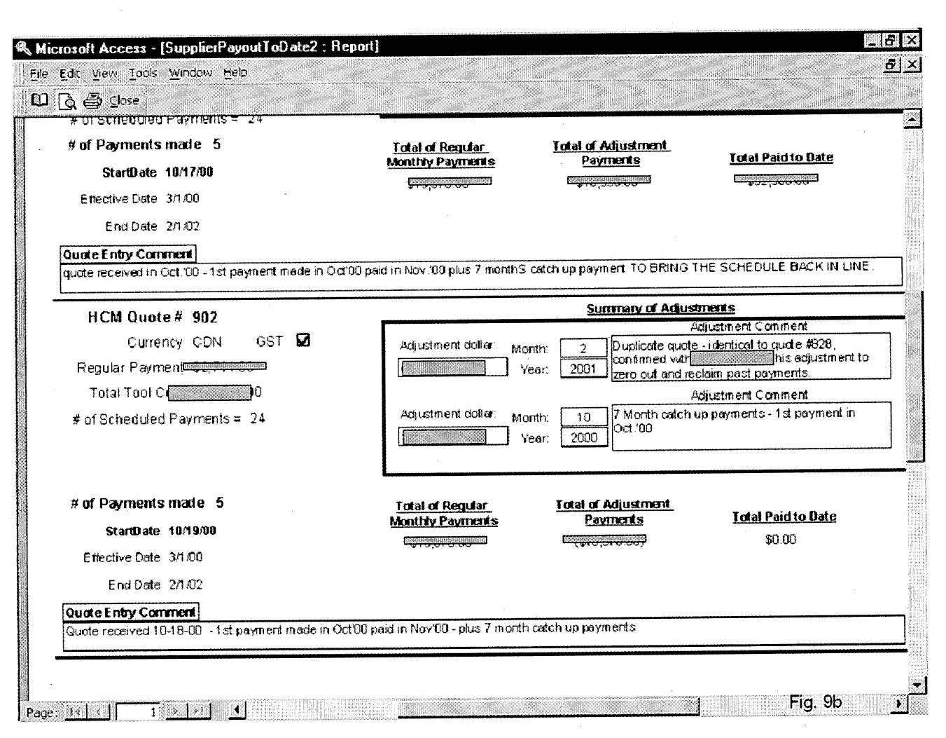

Referring again to FIG. 3, pressing the PAY OUT REPORT button launches a subroutine within the program which presents a screen 114 labeled SELECTION CRITERIA FOR PAY OUT SUMMARY REPORT as shown in FIG. 9, which includes a SELECT PROJECT ID window, a SELECT SUPPLIER NAME window and a CALENDAR window. This screen also includes a PAY OUT REPORT button which, when pressed, instructs the software to a readable display of the payment history on a according to the selected PROJECT ID or SUPPLIER NAME. An example of such a report is found in FIGS. 9a and 9b.

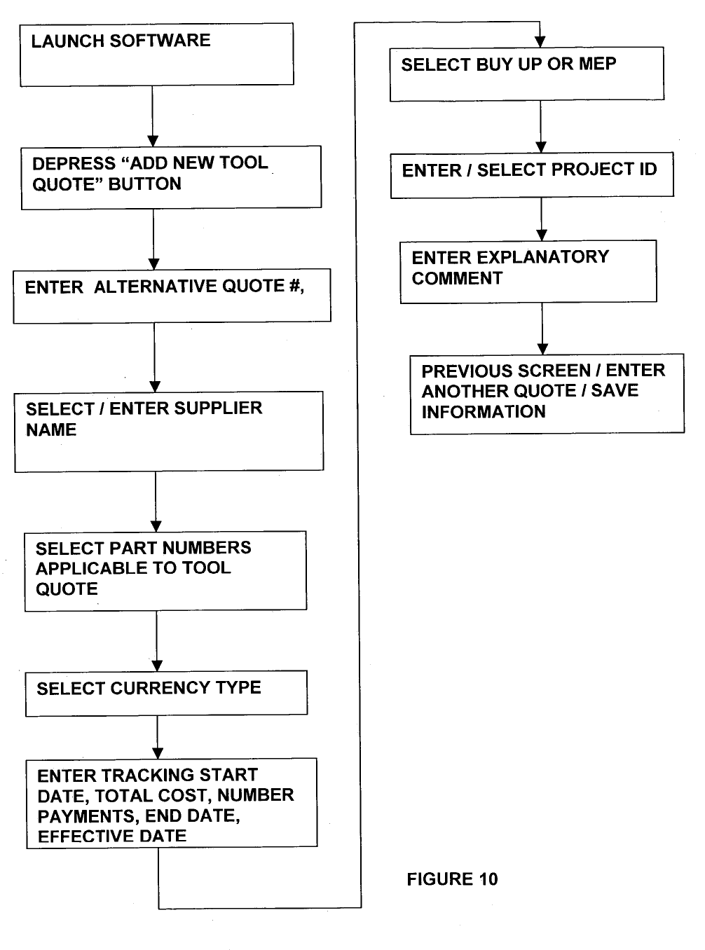

The system 100 is used as follows. Referring to FIGS. 3 and 10, the software is launched, for example by clicking on a desktop icon as is provided under the operating environment available under the trade name WINDOWS™, to present the main menu presented in FIG. 3. The user then depresses the ADD NEW TOOL QUOTE button, instructing the software to present the MONTHLY EQUAL PAYMENTS input screen of FIG. 4. Here, the user finds that the QUOTE # window has been automatically filled in by the software. However, should there be the need for an alternative quote number, such as one which will tie in with the systems of another corporate division for instance, it may be entered in the ALTERNATIVE QUOTE window. The user then proceeds to establish the supplier name in the SUPPORT NAME window, such as by selecting the appropriate name from a drop down list, as shown in FIG. 4a.

As soon as the user enters the supplier information in the corresponding window, the software presents another window asking for part numbers that are applicable to the tool quote currently being processed, as shown in FIG. 4b. Once the part numbers have been entered, the screen of FIG. 4 is returned and the user selects the currency type from the drop down menu list in the corresponding window. The user then enters the appropriate data in the MEP TRACKING START DATE, the ENTER TOTAL COST OF MEP, the ENTER # OF PAYMENTS, the ENTER END DATE and the ENTER EFFECTIVE DATE windows. With this date, the software then calculates the regular payments and presents the value in the REGULAR PAYMENT window. The user then selects either the BUY UP or the MEP option in the corresponding window and then the PROJECT ID data in the corresponding windows. The user then has the option to add explanatory comments in the ENTER COMMENT window. With the data correctly entered, the user then presses any one of three optional buttons on the lower section of the screen 104, namely RETURN TO PREVIOUS SCREEN, ENTER ANOTHER QUOTE, or SAVE INFORMATION.

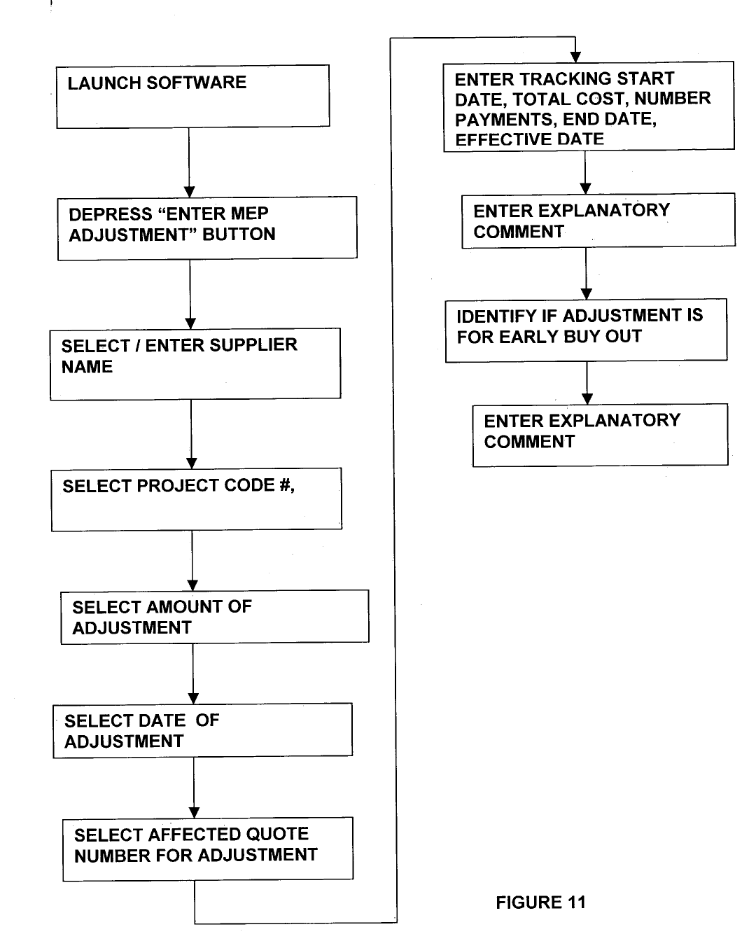

Referring now to FIGS. 3 and 11, the user depresses the ENTER AN MEP ADJUSTMENT button to make a change to the records for a particular payment plan, thus instructing the software to present the ADJUSTMENT ENTRY FORM input screen 106 of FIG. 5. Here, the user selects a SUPPLIER, a PROJECT ID, and enters the amount of the adjustment, in the illustrated example $5000. The user then selects the calendar date on which the adjustment enters into effect. The user then selects the AFFECTED QUOTE NUMBER and checks the appropriate window if the adjustment is an EARLY BUY OUT. The user then has the option to add explanatory comments in the ENTER COMMENT window. With the data correctly entered, the user then presses either one of two optional buttons on the lower section of the screen 106, namely RETURN TO PREVIOUS SCREEN, or SAVE ADJUSTMENT ENTRY.

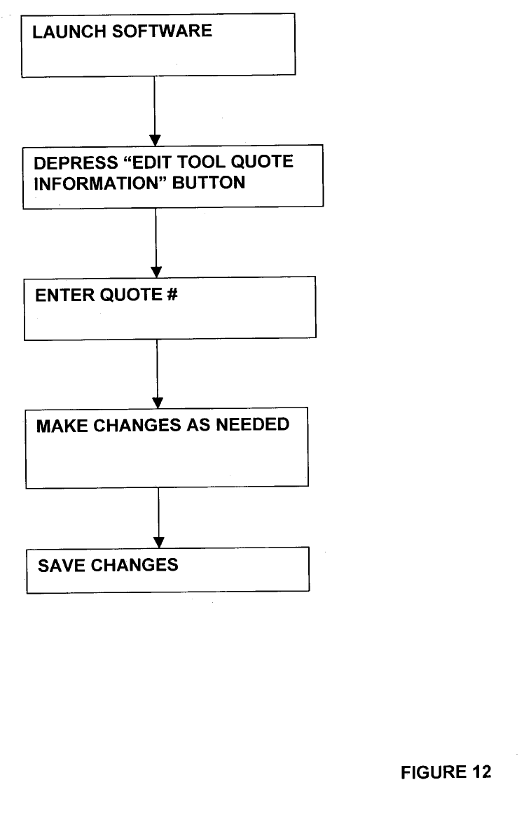

Referring now to FIGS. 3 and 12, the user depresses the EDIT TOOL QUOTE INFORMATION button to make a change to the records for a particular payment plan. This instructs the software to present the SEARCH FORM shown in FIG. 6. Here, the user either enters the QUOTE # information or uses a search option to select the desired quote number. This instructs the software to present the EDIT MEP QUOTE INFO screen 110 as shown in FIG. 7, which enables the user to corrected data, as necessary.

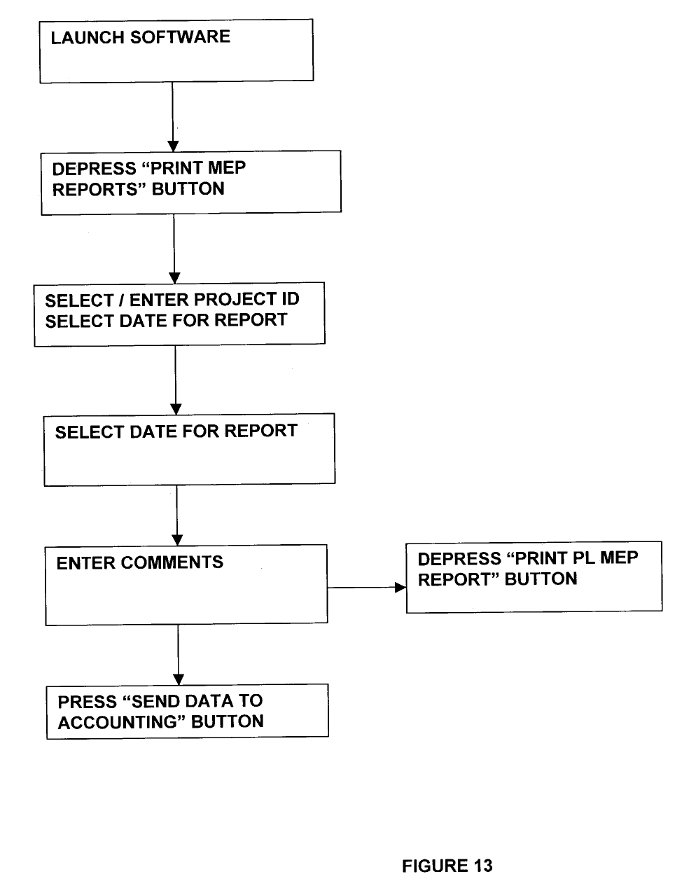

Referring now to FIGS. 3 and 13, the user depresses PRINT MEP REPORTS button to print a report. This instructs the software to present the REPORT PREPARATION screen 112, as shown in FIG. 8. Here, the user selects the applicable project in the PROJECT ID window, the effective date in the CALENDAR window and enters any applicable comments in the COMMENTS window. The user then depresses the SEND DATA TO ACCOUNTING button or the PRINT PL MEP REPORT button. The SEND DATA TO ACCOUNTING button, when pressed, instructs the software to generate a computer file which encodes the payment transaction instruction for the period of time identified in the calendar window. In this case, the computer file may be recorded on an external computer readable medium such as a computer diskette, such as a ⅗ inch disk or that referred to as a CD. Alternatively, the computer file may be conveyed to another user for example a user in another area of an accounting department, by way of a protocol such as a “file transfer protocol” or by way of an attachment to an email message using such meal programs as those available under the trade names OUTLOOK™, EUDORA™, LOTUS NOTES™ and the like. Alternatively, the data contained in the computer readable file may be packaged in one or more other suitable data packets and linked in some other fashion to a payment module either as part of the management system 100 or as a separate management system but resident in the same general purpose or custom programmed computer or on the same computer network.

The PRINT PL MEP REPORT button, when pressed, instructs the software to generate a readable display of the payment transaction instruction, readable by the user, either in paper form, on a screen or in some other manner.

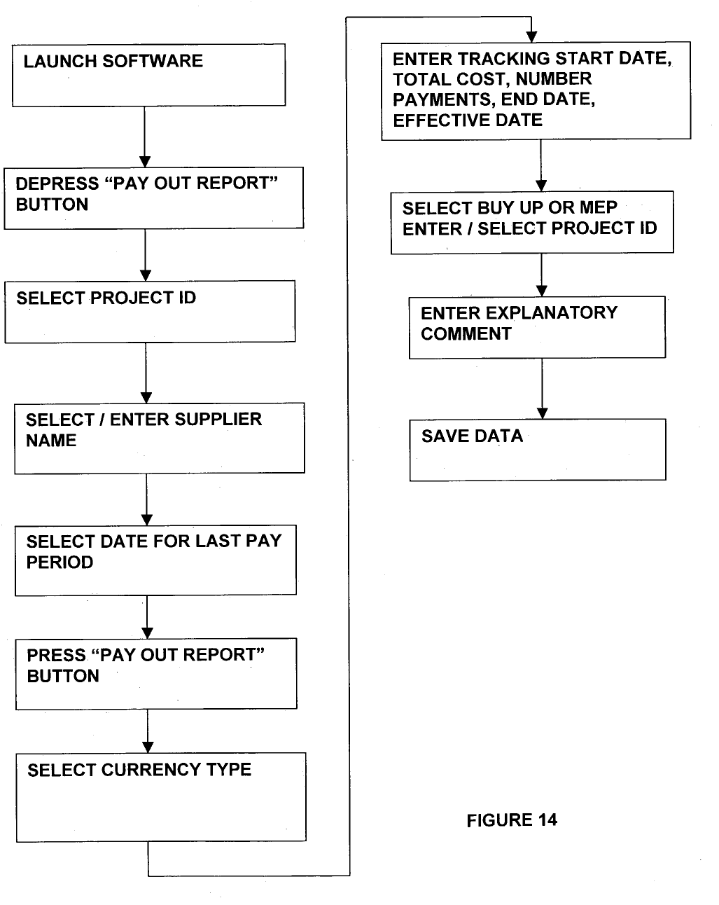

Referring now to FIGS. 3 and 14, the user depresses the PAY OUT REPORT button which instructs the computer to present the screen labeled SELECTION CRITERIA FOR PAY OUT SUMMARY REPORT as shown at 114 in FIG. 9, In it, the user enters the appropriate information in the SELECT PROJECT ID window, the SELECT SUPPLIER NAME window and the CALENDAR window. The user then depresses the PAY OUT REPORT button which instructs the software to generate a readable display of the payment history according to the selected PROJECT ID or SUPPLIER NAME.

While the present invention has been described for what are presently considered the preferred embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A computer implemented management system for use by an automobile manufacturer for consolidating payments to a number of automobile parts suppliers for a number of concurrent individual payment plans, each for one tool purchased from the one of automobile parts suppliers and used in the production of automobile parts by the automobile parts supplier, comprising:
an entry screen module for entering payables data for each tool from the automobile parts supplier; the entry screen module having a number of fields to receive a number of data items including:
a time period over which payments are to be made; and
a total amount to be paid over the time period;
the fields also including one or more of:
a tool identification code;
an automobile parts supplier identification code;
a payment plan start date;
a payment plan end date; and
a payment plan rate;
a calculation module for calculating a payment plan for each of the incremental payments to be made over the payment period, said accounting module generating a data set encoding the payment plan;
a database for storing the data sets;
a payment module for assembling a payment transaction instruction for each of a series of successive payment periods, the payment transaction instruction including a payment code for each of the automobile suppliers due to be paid in the payment period, each payment code including the incremental payments to a corresponding automobile supplier; and
an output module for generating an output report including the payment transaction instruction.

2. A system as defined in claim 1 wherein the entry screen module further provides a graphical user interface including a window corresponding to each field.

3. A system as defined in claim 2 wherein the windows corresponding to the tool identification code, the automobile parts supplier identification code each include a window menu.

4. A system as defined in claim 1 wherein the entry screen module further comprises a quote number generator for assigning one or more quote numbers for each data set.

5. A system as defined in claim 2 wherein the graphical user interface further includes a window, with or without a window menu, to select a currency for the data set.

6. A system as defined in claim 2 wherein the graphical user interface further includes a window, with or without a window menu, to select an alternative condition where the data set covers only one incremental payment.

7. A system as defined in claim 2 wherein the graphical user interface further includes a window to receive text comments concerning a payment plan for a particular tool.

8. A system as defined in claim 2 wherein the graphical user interface further includes a window, with or without a window menu, to select a project in which the subject tool is to be used.

9. A system as defined in claim 8 wherein the graphical user interface further includes a window, with or without a window menu, to select an internal entity within the automobile manufacturer who has responsibility for the subject tool.

10. A system as defined in claim 1 wherein the entry screen module includes a graphical user interface which provides a first user-initiated function to enter a new tool quote, and/or a second user-initiated function to adjust one or more of the incremental payments for a subject tool, and/or a third user-initiated function to edit an existing data set for adjust one or more of the incremental payments for a subject tool.

11. A system as defined in claim 10, wherein the graphical user interface further comprises a window, operable in response to the first, second or third user-initiated functions, with or without a window menu, to select a parts supplier.

12. A system as defined in claim 10, wherein the graphical user interface further comprises a window, operable in response to the first, second or third user-initiated functions, with or without a window menu, to select a project code.

13. A system as defined in claim 10, wherein the graphical user interface further comprises a window, operable in response to the first, second or third user-initiated function, with or without a window menu, to select an effective adjustment date.

14. A system as defined in claim 10, wherein the graphical user interface further comprises a window, operable in response to the first, second or third user-initiated functions, with or without a window menu, to select a quote number for the subject tool.

15. A system as defined in claim 10, wherein the graphical user interface further comprises a window, operable in response to the first or second user-initiated function, with or without a window menu, to identify if the adjustment is an early buy out.

16. A system as defined in claim 10, wherein the graphical user interface further comprises a window, operable in response to the first or second user-initiated function, with or without a window menu, to enter text for explanatory comments on the adjustment.

17. A system as defined in claim 10, wherein the graphical user interface further comprises a window, operable in response to the first user-initiated function, with or without a drop down menu, to select a quote number.

18. A system as defined in claim 1 wherein the payment code includes a sum of the incremental payments to each of the automobile suppliers and an identification of each of the incremental payments included in the sum.

19. A system as defined in claim 1 wherein selected ones of the payment transactions are recorded on or transferred by suitable media for use by a subsequent payment module.

20. A system as defined in claim 19 wherein the media is a computer readable medium.

21. A system as defined in claim 19 wherein the media is a data-bearing message.

22. A system as defined in claim 19 wherein the subsequent payment module is resident therein.

23. A computer-readable data structure for use by an automobile manufacturer, encoded on a computer readable medium, for consolidating payments to a number of automobile parts suppliers for a number of concurrent individual payment plans, each for one tool purchased from the automobile parts supplier and used in the production of automobile parts by the automobile parts supplier, comprising:
a plurality of automobile parts supplier data groups, each for storing information for a corresponding automobile parts supplier, each of said automobile supplier data groups including a plurality of automobile parts supplier tool account subgroups, each for storing information for a corresponding automobile parts supplier tool account,
each of said tool account subgroups including a plurality of entry data sets, one of said data sets for receiving data encoding a time period over which payments are to be made; and another of said data sets for receiving data encoding a total amount to be paid over the time period;
the tool account subgroups also including a plurality of data sets, each for receiving data encoding one or more of a tool identification code, an automobile parts supplier identification code, a payment plan start date, a payment plan end date, and a value for each incremental payment to be made over the time period, and a payment plan rate.

24. A data structure as defined in claim 23, wherein the data groups further comprise one or more data sets for encoding a payment transaction, the data sets including a payment code for at least one of the automobile suppliers due to be paid in the payment period, the payment code including a sum of each of the incremental payments to each of the automobile suppliers.

25. A computer program product encoded in a computer readable medium including a plurality of computer executable steps for consolidating payments to a number of suppliers for a payment plan for a plurality of tools used in the production of articles, comprising:
generating a payment plan, including the steps of:
generating an entry screen for receiving data for each tool from each supplier, including, in the entry screen, a first field for receiving a time period over which payments are to be made, a second field for receiving a total amount to be paid over the time period, a number of fields including: a tool identification code, a parts supplier identification code, a payment plan start date, a payment plan end date, and a payment plan rate;iod,
calculating a payment plan for each of the incremental payments to be made over the payment period;
generating a data set encoding the payment plan for each supplier;
storing the data sets; and
generating a consolidated payment for at least one of the suppliers, including the step of:
assembling a payment listing for each of a series of successive regular payment periods, the payment output including a payment code for at least one of the suppliers due to be paid in the payment period, the payment code including a sum of each of the incremental payments to each of the suppliers.

26. A computer program product as defined in claim 25, further comprising the step of generating an output report including the payment listing.

27. A computer implemented management system for use by an automobile manufacturer for consolidating payments to a number of automobile parts suppliers for a number of concurrent individual payment plans, each for one tool purchased from the one of automobile parts suppliers and used in the production of automobile parts by the automobile parts supplier, comprising:
an entry screen means for entering payables data for each tool from the automobile parts supplier; the entry screen means having a number of fields to receive a number of data items including:
a time period over which payments are to be made; and
a total amount to be paid over the time period;
the fields also including one or more of:
a tool identification code;
an automobile parts supplier identification code;
a payment plan start date;
a payment plan end date; and
a payment plan rate;
calculation means for calculating a payment plan for each of the incremental payments to be made over the payment period, said accounting module generating a data set encoding the payment plan;
data storage means for storing the data sets;
payment means for assembling a payment transaction instruction for each of a series of successive payment periods, the payment transaction instruction including a payment code for each of the automobile suppliers due to be paid in the payment period, each payment code including the incremental payments to a corresponding automobile supplier; and
output means for generating an output report including the payment transaction instruction.

28. A computer implemented method for consolidating payments to a number of suppliers for a payment plan for a plurality of tools used in the production of articles, comprising:
a step for generating a payment plan, including:
a step for generating an entry screen for receiving data for each tool from each supplier, including, in the entry screen, a first field for receiving a time period over which payments are to be made, a second field for receiving a total amount to be paid over the time period, a number of fields including: a tool identification code, a parts supplier identification code, a payment plan start date, a payment plan end date, and a payment plan rate;
a step for calculating a payment plan for each of the incremental payments to be made over the payment period;
a step for generating a data set encoding the payment plan for each supplier;
a step for storing the data sets; and
a step for generating a consolidated payment for at least one of the suppliers, including:
a step for assembling a payment listing for each of a series of successive regular payment periods, the payment output including a payment code for at least one of the suppliers due to be paid in the payment period, the payment code including a sum of each of the incremental payments to each of the suppliers.
